(19) United States
(12) Patent Application Publication
(10) Pub. No.: US 2009/0018931 A1
(43) Pub. Date: Jan. 15, 2009

(54) SYSTEM AND METHOD FOR A BUSINESS TRANSACTION INITIATION PROTOCOL

(75) Inventors: Breckenridge W. Kling, Rochester, NY (US); Gustavo Paz-Pujalt, Rochester, NY (US)

Correspondence Address: HARRIS BEACH PLLC, 99 GARNSEY ROAD, PITTSFORD, NY, 14534, US

(73) Assignee: Breckenridge W. Kling, Rochester, NY (US)

(21) Appl. No.: 12/168,502

(22) Filed: Jul. 7, 2008

Related U.S. Application Data
(60) Provisional application No. 60/958,414, filed on Jul. 5, 2007.

(51) Int. Cl. G06Q 30/00

(52) U.S. Cl. 705/27

(57) ABSTRACT

A system and method are disclosed for engaging two or more parties in a buyer-initiated transaction interaction where the asset that is the subject is not available for sale or the requesting party is unaware that the asset is available for sale or use. The requesting party identifies the asset is the subject of the transaction and contacts an intermediary. The intermediary initiates the transaction interaction with the owner of the asset by presenting the owner with a premium.

### RELATED APPLICATIONS

This application claims the benefit of U.S. Provisional Application No. 60/958,414 filed Jul. 5, 2007.

### FIELD OF THE INVENTION

The invention relates generally to the field of business transactions and, more specifically, to a system and method for conducting a buyer-initiated business transaction interaction. In particular, the invention relates to a system and method for conducting a buyer-initiated business transaction interaction where the asset or service to be purchased is not available for sale, or where the buyer does not know that the asset or service to be purchased is for sale.

### BACKGROUND OF THE INVENTION

The bulk of buying and selling transactions in today's market are seller initiated. Sellers commonly advertise products and services for sale in newspapers, magazines, billboards, posters and other such publicly available media. Seller advertisements through electronic media such as radio, television and the internet are also prevalent. These seller-initiated systems for conducting business transactions are limited, however, in that a buyer may wish to purchase an asset or service which is not available for sale, or the availability of which the buyer is unaware.

Although buyer-initiated transactions take place, such transactions are difficult to initiate and are often inefficient. When a prospective buyer initiates contact with the owner of an asset that is not available for sale several difficulties arise. Initially, the owner may feel intruded upon as the result of receiving an unsolicited offer. Additionally, it is not easy for the owner to evaluate the prospective buyer's level of commitment or financial ability to purchase the asset in question under such circumstances. The owner, who was not looking to sell at the time of the initial contact, also lacks critical information regarding the market value of the asset. Further, an owner, after receiving an unsolicited offer for his or her asset, is likely to develop unreasonable expectations with the amount of compensation he or she may receive, which may prevent an otherwise viable sale. Finally, in the event that the offer is welcomed and negotiations are entered into, the process is inefficient because the parties will likely need to engage third parties to help facilitate the transaction.

As such, there is a need to provide an efficient system and method for conducting a buyer-initiated business transaction. There is also a need to provide a system and method to enter into a buyer-initiated business transaction which demonstrates both the sincerity of the buyer and his ability to complete the business transaction, and where the party which owns the desired asset or provides the desired service will feel flattered as opposed to intruded upon as a result of the buyer-initiated transaction. Finally, there is a need to provide a system and method to enter into a buyer-initiated business transaction that indicates and evaluates third parties necessary to complete the transaction.

### SUMMARY OF THE INVENTION

The present invention provides a method of engaging two or more parties in a transaction interaction. The method comprises an intermediary service provider receiving the identification of at least one asset for transaction interaction from a requesting party. The owner may not be actively selling the asset or the requesting party may be unaware that the asset is available for sale or use.

Once the asset is identified, the owner of the asset is identified and located. The requesting party may be prequalified to obtain the asset prior to contacting the owner. The owner of the asset is contacted and presented with a premium to encourage entrance into the transaction interaction. The premium possesses intrinsic value and may be redeemable for a product or a service. The premium may be provided by a premium provider whose activities are directed by the intermediary service provider. The method further comprises coordinating and completing the transaction interaction. The method also comprises identifying at least one third party that can provide services to either the requesting party, the owner, or both parties. The anonymity of either the requesting party, the owner, or both parties may be maintained throughout the transaction interaction. Further the requesting party may be provided with historical information about the asset.

The present invention also provides a system for engaging two or more parties in a transaction interaction. The system includes an intermediary who facilitates the transaction interaction for a requesting party by contacting an owner of an asset. The intermediary presents a premium to the owner of the asset on behalf of the requesting party. Alternatively, a premium provider may be utilized to present to the premium to the owner on behalf of the intermediary. The system also includes a database containing information regarding the transaction interaction.

### BRIEF DESCRIPTION OF THE DRAWINGS

The foregoing and other objects, features, and advantages of the invention will be apparent from the following more particular description of the embodiments of the invention.

FIG. 1 represents a system for conducting a buyer-initiated business transaction interaction in accordance with the present invention.

FIG. 2 represents another embodiment of a system for conducting a buyer-initiated business transaction interaction in accordance with the present invention.

FIG. 3 represents a method for conducting a buyer-initiated business transaction interaction in accordance with the present invention.

FIG. 4 represents one embodiment of a method for initiating the business transaction interaction in accordance with the present invention.

FIG. 5 represents one embodiment of a method for completing the business transaction interaction in accordance with the present invention.

### DETAILED DESCRIPTION OF THE INVENTION

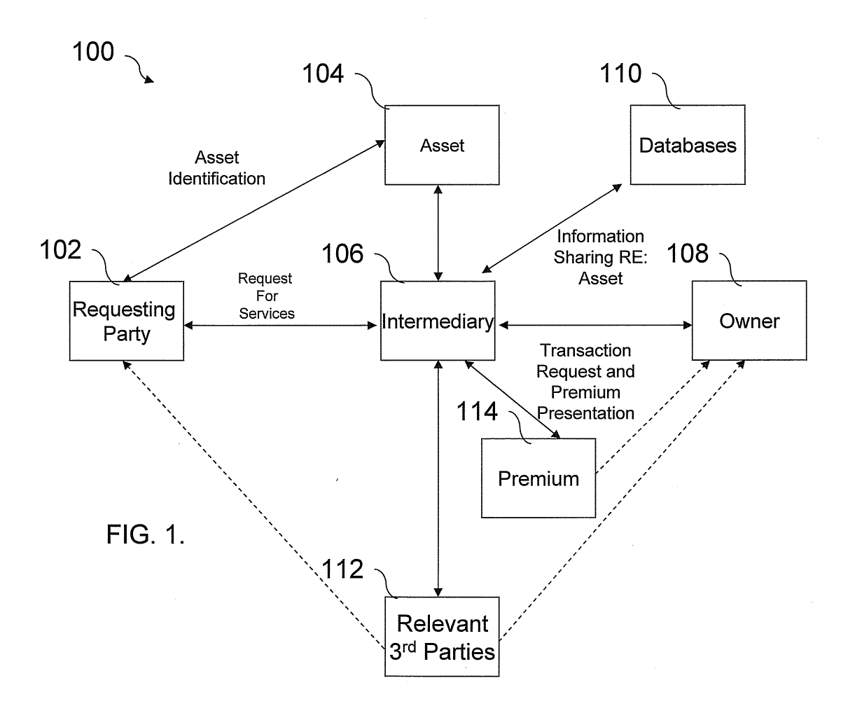

The present invention is a system and method for conducting a buyer-initiated business transaction interaction. FIG. 1 represents a system 100 for conducting a buyer-initiated business transaction interaction in accordance with the present invention. A requesting party 102 identifies at least one asset 104, which is either unavailable for sale or not known to be available for sale or use by the requesting party 102. The asset 104 may be any tangible object or service upon which the potential buyer 102 places value. The asset 104 may include real estate, a fine art work, an introduction to a difficult to contact individual, the swapping of a vacation home or apartment for a period of time, or any other asset upon which the requesting party 102 places value. Upon identification of the asset 104, the requesting party 102 contacts an intermediary 106 with a request for services to identify and contact an owner 108 of the asset 104.

In one embodiment, the intermediary 106 identifies the owner 108 of the asset 104. The intermediary 106 may identify the owner 108 through a variety of means, including but not limited to, communication from the requesting party 102, referring to a database 110 such as public records, the internet, or a proprietary database, or direct personal interaction using professional services or a network of knowledgeable friends and associates. The database 110 may be linked to a website maintained by the intermediary 106.

Upon identification of the owner 108, the intermediary 106 contacts and informs the owner 108 of the interest for the asset 104. The intermediary 106 also provides the owner 108 with a premium 114 to entice the owner 108 to enter into negotiations with the requesting party 102 and to validate the intent of the requesting party 102. The premium 114 is a gift offered to the owner 108 as a sign of good faith on the part of the requesting party 102 and is presented to the owner 108 irrespective of his willingness to enter into a negotiation for the asset 104. The premium may be a piece of jewelry, tickets to a play, a pass for golf at an exclusive venue, or other item of value. The premium 114 is selected to convey the quality and branding of the intermediary 106 and the service the intermediary 106 provides to both the requesting party 102 and to the owner 108. The premium 114 may be branded to convey the exclusivity and quality of the service of the intermediary 106. The intermediary 106 also provides the owner 108 with information related to the requesting party, or to the market value of the asset to manage the owner's expectations with regard to the potential sale.

In one embodiment, the intermediary 106 identifies and evaluates one or more third parties 112 which may provide services related to the asset 104 or relevant accessories to the asset 104. The third parties 112 may be of use to the requesting party 102, the owner 108, or both parties in facilitating the transaction. The third parties 112 may be engaged in any of several professions including, but not limited to: real estate agents, website managers, attorneys, inspectors, general contractors, art appraisers, chocolatiers and florists. The third parties may also include sponsors which provide funds to pay a portion, or the entire cost, of the premium 114 to encourage the initiation of the transaction. The efficiency of the transaction interaction is improved by the reduced time spent by the requesting party 102 or the owner 108 in finding third parties 112 to facilitate the transaction. Further, the evaluation of the third parties 112 by the intermediary 106 increases the usefulness of the services.

One feature of the present invention is that the requesting party 102 may remain anonymous to the owner 108 while negotiations regarding the asset 104 are on-going. Another feature of the present invention is that the requesting party 102 may remain anonymous to all third parties 112 engaged by the intermediary 106 while negotiations for services from the third parties 112 are on-going and while negotiations regarding the asset 104 are on-going. Similarly, the owner 108 may remain anonymous to the requesting party 102 while negotiations regarding the asset 104 are on-going. Another feature of the present invention is that the owner 108 may remain anonymous to all third parties 112 engaged by the intermediary 106 while negotiations for services from the third parties 112 are on-going and while negotiations regarding the asset 104 are on-going. Another feature of the present invention is that the confidentiality of the requesting party 102 and owner 108 can be maintained through appropriate documentation created by or for the intermediary 106.

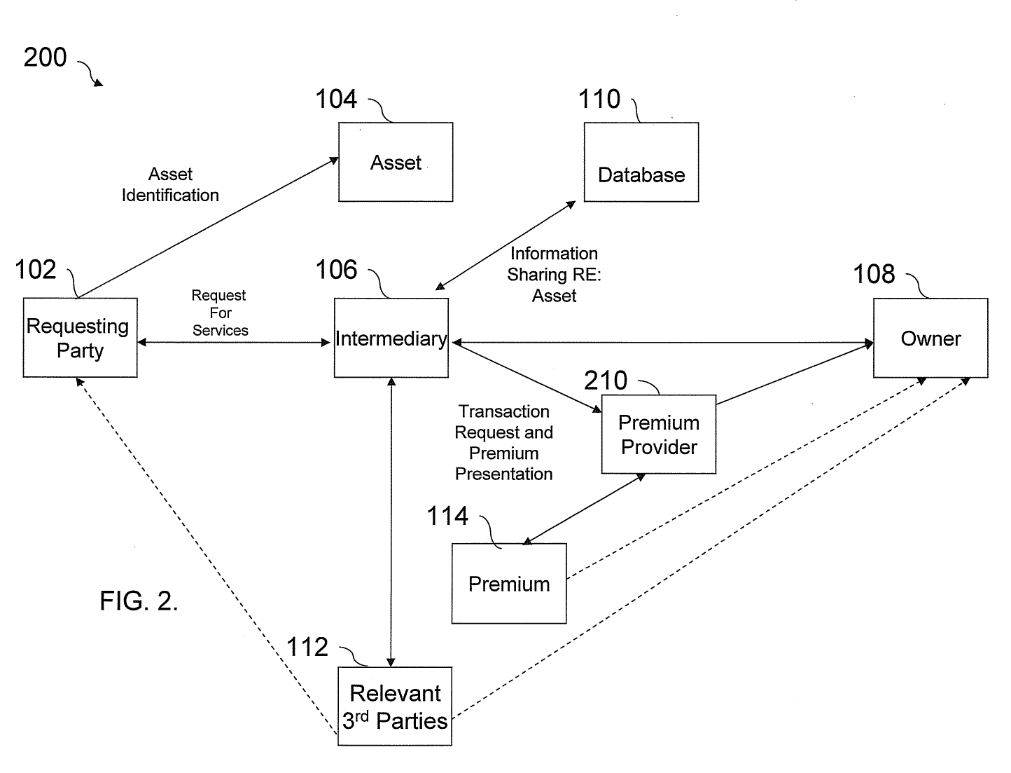

FIG. 2 represents another embodiment of a system 200 for conducting a buyer-initiated business transaction interaction in accordance with one aspect the present invention. In this embodiment, the premium 114 is presented to the owner 108 through a premium provider 210. The premium provider 210 is a separate entity that bears responsibility for procuring and delivering the premium 114 to the owner 108.

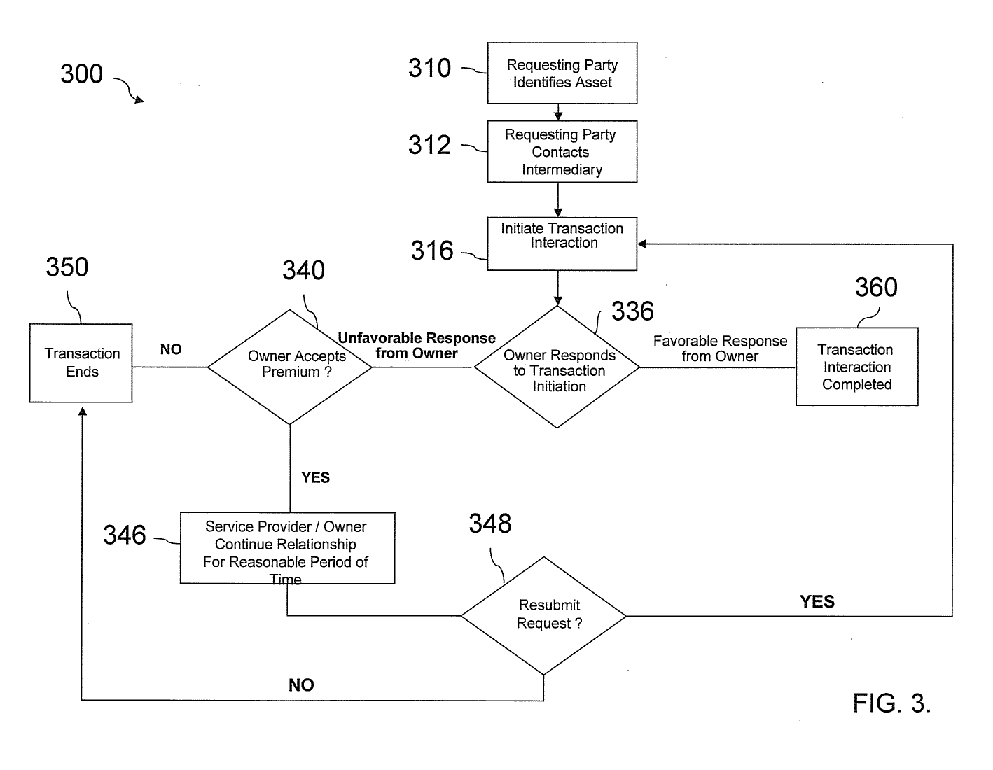

FIG. 3 represents a method for conducting a buyer-initiated business transaction interaction in accordance with one aspect of the present invention. In step 310 a requesting party identifies at least one asset he/she wishes to purchase through an electronic medium, such as the internet. In one embodiment, the asset the requesting party wishes to purchase is not currently available for sale or use. In another embodiment, the owner of the asset is not known to the requesting party. After the requesting party has identified the asset, the requesting party contacts an intermediary service provider in step 312. The intermediary may be contacted using the internet or other electronic means, or conventional means such as responding to an advertisement in conventional media or looking up the intermediary in a phone book. In step 316 the intermediary initiates the business transaction interaction.

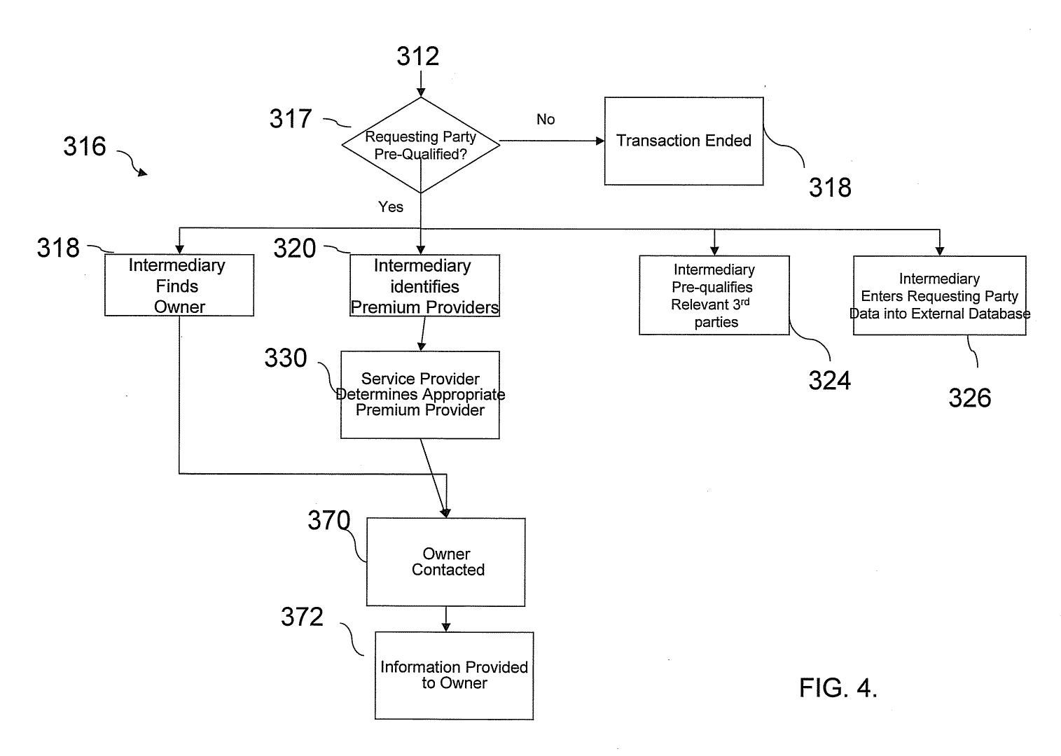

FIG. 4 represents one embodiment of a method for initiating the business transaction interaction as in step 316. In step 317 the intermediary determines whether the requesting party pre-qualifies to purchase the desired asset. The pre-qualification may include credit checks, a personal meeting, due diligence and other such well known methods to verify the identity, financial capabilities and character of the requesting party. If the intermediary determines that the requesting party does not meet the conditions for successful prequalification in step 317, then the transaction initiation is terminated in step 318. If the requesting party meets the conditions for prequalification in step 317 the intermediary identifies and locates the owner of the asset in step 319. The intermediary may use available databases to identify and locate the owner.

The intermediary also identifies at least one premium provider in step 320. The premium provider may provide either goods or services. The cost of the premium may be paid by the requesting party, a third party acting as a sponsor or a combination of the two. In step 330 the intermediary determines the appropriate premium provider to supply the premium to the owner. The intermediary may provide the premium itself or engage a separate premium provider. The intermediary may determine the appropriate premium provider based upon input from the requesting party.

In step 324 the intermediary pre-qualifies relevant third parties may be of use to the requesting party, the owner or both parties in facilitating the transaction. The prequalification may include a determination as to the quality of the services and the reputation of the third parties. The intermediary also inputs data regarding the requesting party into a database in step 326.

Once the intermediary has determined the appropriate premium provider, the seller is contacted in step 370. In step 372 the intermediary or the premium provider provides the owner with information regarding the requesting party. The information will not necessarily include contact information so the requesting party may remain anonymous to the owner. The seller will be provided information in enough detail to make a determination as to whether the requesting party is acceptable for the purchase of the asset. The intermediary also may provide information related to the market value of the asset to manage the owner's expectations in negotiating a sale of the asset. The owner may also receive a means to pursue the offer, such as a URL link where the owner can receive additional information related to the requesting party and the asset.

Referring again to FIG. 3, the owner responds to the transaction initiation in step 336. If the owner responds unfavorably to the transaction initiation, then the owner must decide whether to accept the premium in step 340. If the owner does not accept the premium the process ends in step 350. If the owner does accept the premium, then the relationship between the intermediary and the owner continues for a reasonable period of time in step 346. While this relationship continues the owner is bound to the intermediary if the owner decides to enter a negotiation with the same or another buyer. In step 348 the requesting party may decide to make additional requests to the owner to enter into a negotiation by revising and resubmitting the request, so long as the request has not been made excessively. An excessive number of requests will be apparent to one skilled in the art. If the requesting party decides not to resubmit the request the transaction ends in step 350. If the requesting party decides to resubmit the request the transaction initiation in step 316 is repeated. If the owner responds favorably to the transaction initiation, the transaction is completed in step 360.

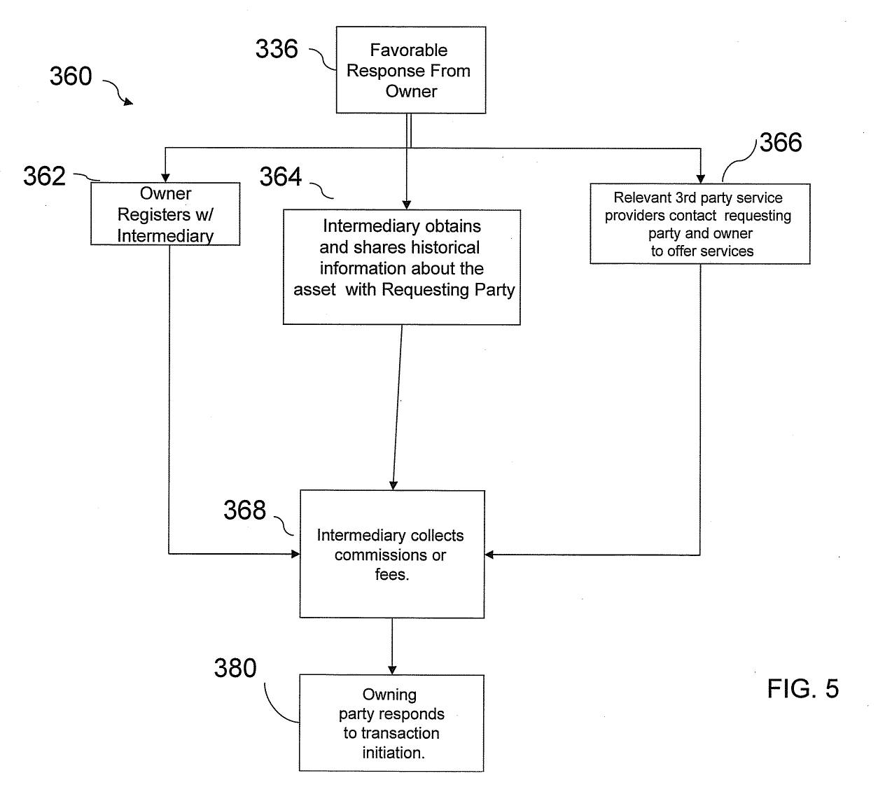

FIG. 5 depicts a method for completing step 360 in accordance with one aspect of the present invention. In step 362 the owner registers with the intermediary. The owner may agree to be bound to work with the intermediary for a reasonable period of time to allow the intermediary to complete a transaction for the asset even if the current negotiation terminates unsuccessfully. Further, in registration, the data of the owner may be entered into a database to facilitate future transactions with the owner and other requesting parties. The owner may allow other potential buyers to obtain access to a portion of this data.

In step 364 the intermediary obtains historical information about the asset and shares that information with the requesting party. The historical information may include a listing of owners and dates of ownership, damage sustained by the asset, any disputes as to ownership, sales prices upon ownership transfer, periods when the asset was leased or on loan, and other such data. The historical information may be gathered from any of several sources including, but not limited to, the owner, public records, and private investigation. Any gathered data, historical, or otherwise, regarding the asset, is stored in a database for the use of the intermediary. The intermediary may provide access to a portion, or all, of the gathered data to outside parties as is necessary to complete the negotiation. The outside party may provide compensation to the intermediary to access this data. Alternatively, a sponsor may provide compensation to the intermediary. The intermediary may also provide the opportunity for the owner to opt into allowing the intermediary to offer the data for sale to other outside parties.

In step 366 relevant third parties identified and evaluated by the intermediary contact one or both of the requesting party and the owner, as appropriate, to assist the transaction. This assistance may consist of services, items which are ancillary to the asset, or a combination of the two.

In step 368 the intermediary may collect commissions from the appropriate parties. The appropriate parties will come from the group of the requesting party, the owner, and the relevant third parties. The data related to the transaction may be sold at a fee or on commission to additional parties or a sponsor that pays in totality or in part for the data. In step 380 the requesting party and the owner enter into negotiations related to the asset.

While illustrative embodiments have been presented and described, it will be clear to those proficient in the art that various changes can be made therein without departing from the spirit and scope of the invention.

What is claimed is:

1. A method of engaging two or more parties in a transaction interaction comprising:
receiving the identification of at least one asset for transaction interaction from a requesting party through the internet;
identifying an owner of the asset;
contacting the owner;
presenting the owner with a premium;
providing the owner with market value information related to the asset.

2. The method of claim 1 wherein the owner is not actively selling the asset.

3. The method of claim 1 wherein the requesting party is unaware that the asset is available for sale or use by the requesting party.

4. The method of claim 1 further comprising:
coordinating the transaction interaction between the requesting party and the owner of the asset.

5. The method of claim 1 wherein the premium is redeemable for a product or a service.

6. The method of claim 1 wherein the premium possesses intrinsic value.

7. The method of claim 1 wherein the premium is supplied by a premium provider.

8. The method of claim 7 further comprising:
directing the activities of the premium provider.

9. The method of claim 1 further comprising:
identifying at least one third party that can provide services to either the requesting party, the owner, or both parties.

10. The method in claim 10 further comprising:
evaluating the qualifications of the third party.

11. The method of claim 1 further comprising:
maintaining the anonymity of either the requesting party, the owner, or both parties.

12. The method of claim 1 further comprising:
providing the requesting party with historical information about the asset.

13. The method of claim 1 further comprising:
pre-qualifying the requesting party to obtain the asset.

14. A system for engaging two or more parties in a transaction interaction comprising:
an intermediary that facilitates the transaction interaction for a requesting party by contacting an owner of an asset; and
a premium presented by the intermediary on behalf of the requesting party to the owner.

15. The system of claim 14 further comprising a premium provider that presents the premium to the owner.

16. The system of claim 14 further comprising a database containing information regarding the asset.

17. The system of claim 16 wherein the database contains information related to the market value of an asset that is the subject of the transaction interaction.
